(19) United States
(12) Patent Application Publication
(10) Pub. No.: US 2026/0357805 A1
(43) Pub. Date: Nov. 12, 2026

(54) METHOD FOR CONTROLLING A COMPRESSOR SYSTEM WITH SEVERAL COMPRESSORS

(71) Applicant: KAESER KOMPRESSOREN SE, Coburg (DE)

(72) Inventors: Florian WAGNER, Coburg (DE); Tobias SPRÜGEL, Coburg (DE)

(21) Appl. No.: 19/134,769

(22) PCT Filed: Nov. 9, 2023
(86) PCT No.: PCT/EP2023/081242

§ 371 Date: Jun. 2, 2025

(30) Foreign Application Priority Data
Dec. 2, 2022 (DE) 10 2022 132 003.0

(51) Int. Cl. F04C 28/02; F04C 18/16

(52) U.S. Cl. CPC F04C 28/02; F04C 18/16

(57) ABSTRACT

The invention relates to a method for controlling a compressor system (100) comprising multiple compressors (C1, C2, . . . ) for generating compressed gas, in particular compressed air, for at least one load (200) and to a corresponding control unit (300) and a compressor system (100). The method has the steps of: determining multiple future system states (St_{n,m}) of the compressor system (100) using a simulation; determining similar system states (Stₙ,ₛiₘ) from the quantity of future system states (Stₙ) determined for a future point in time (tn); reducing the quantity of system states (Stₙ) determined for a future point in time (tₙ) by rejecting at least one system state from the quantity of determined similar system states (Stₙ,ₛiₘ); determining an optimal compressor operating state combination sequence (CSseqₒₚₜ) with respect to a quality criterion, which is preferably an energy efficiency criterion; and outputting at least one control command (LC1, LC2, LC1/LC2) which is suitable for producing an operation of the compressors (C1, C2, . . . ) of the compressor system (100) that corresponds to at least one part of the optimal compressor operating state combination sequence (CSseqₒₚₜ).

The invention relates to a method for controlling a compressor system comprising a plurality of compressors for generating compressed gas, in particular compressed air, for at least one consumer, as well as a control unit for a compressor system and a compressor system.

Industrial compressor systems for the generation of compressed air (compressed air systems) are operated to provide compressed air for the operation of processes and machines. The compressed air system typically comprises one or more compressors as compressed air generators. One or more compressed air consumers are connected to the compressed air system via a compressed air network and are supplied with compressed air as required.

The compressed air demand of the compressed air consumers, which is typically indicated by the consumption volume flow, is not constant over time. The total demand of all compressed air consumers results in the instantaneous consumption volume flow CVF(t) by superimposing the respective individual demands. The operation of the connected consumers is usually not synchronized in time, resulting in a varying compressed air demand.

A compressed air system typically also includes compressed air treatment components (e.g. filters, condensate separators, oil separators, dryers, etc.), compressed air storage tanks and other components such as pipes and valves. Oil-injected compressors comprise an oil circuit and use oil injected into the compression chamber for cooling and lubrication.

For decades, the use of cascade circuits with pressure switches has been common practice in the field of compressed air generation, wherein several compressors are switched on or off in a defined sequence by a pressure switch. A specified pressure band is limited by a minimum pressure and a maximum pressure. If the pressure falls below the specified minimum pressure, a compressor is switched into load (and supplies compressed air); if the specified maximum pressure is exceeded, a compressor is switched out of load (and does not supply compressed air). The upper and lower pressure limits of the individual compressors are typically shifted in relation to each other so that the pressure switch switches the compressors on or off in sequence. The specific operating status (e.g. standstill, idling, load running) of a particular compressor is only indirectly influenced by the pressure switch.

In known cascade circuits with pressure switches, there is no adaptation to changes or fluctuations in compressed air consumption. The pressure switch settings are always the same for operating phases with different compressed air consumption, wherein the selected settings must cover all phases of compressed air consumption that occur. In this respect, the appropriately set pressure switch represents a compromise that does not guarantee optimum control. Finding the appropriate pressure switch settings requires a great deal of system and consumer-specific knowledge and experience. In addition, pressure switches do not take into account the fact that when a load command is issued to a compressor (command to switch the compressor to a load state), a motor start may be required first, which is why the minimum pressure must be set significantly higher than the pressure that the compressed air storage tank should not actually fall below in order to cover the desired compressed air consumption. This leads to an increased average system pressure, which has a negative impact on energy efficiency.

WO 2010/072803 A1 describes a simulation-based method for controlling or regulating compressed air stations. Changes in the pressure in the compressed air station are to be anticipated as early as possible in order to initiate suitable switching actions. Before a switching strategy is initiated, various switching strategies are tested in a pre-simulation procedure based on a model of the compressed air station. A switching strategy is understood to be a sequence of switching actions, i.e. a discrete or continuous change of control variables, which cause a change in the operation of one or more components of the compressed air station. The relatively most advantageous switching strategy is selected on the basis of a quality criterion and implemented in the compressed air station. No optimization problem is solved, but only a limited number of selected switching strategies to be investigated are examined more closely in a preliminary simulation in order to determine the best solution from this limited selection of switching strategies. There is a very high probability that the optimum switching strategy will not be found.

EP 3 974 918 A1 describes a computer-implemented control method for a compressed air system with one or more compressors. A future course of a process variable is sampled at a sampling rate based on the volume of the compressed air system. Using an MPC method (Model Predictive Control, MPC), the sampled future course of the process variable is converted into a course of action over a predetermined first time horizon and into a state course over a predetermined second time horizon of the same size or larger, wherein the course of action includes in particular the switching of compressors. The temporal resolution can be changed adaptively by using different sampling rates. Particularly with dynamic processes, the increase in the sampling rate (higher temporal resolution) and the time horizon that can be predicted with sufficient accuracy is limited by the available computing capacity.

The present invention has the object of overcoming disadvantages from the prior art. In particular, the invention has the object of providing a control method for a compressor system with a plurality of compressors for generating compressed gas (compressed air) for at least one consumer, which ensures the best possible, in particular most efficient, operation of the compressor system for providing the demand for compressed gas (compressed air). In particular, the control method should react as early as possible to the future consumption of compressed gas (compressed air) and, in particular, be able to take into account dynamic influencing variables and/or processes in the compressor system as accurately as possible. Preferably, the control method should be real-time capable.

This object is solved by a method according to claim 1, a control unit according to claim 19, a compressor system according to claim 20, a computer program according to claim 21 and a computer-readable storage medium.

The said object is solved in particular by a method for controlling a compressor system comprising a plurality of compressors for generating compressed gas, in particular compressed air, for at least one consumer, comprising:
Determining a plurality of future system states of the compressor system for at least one future point in time, wherein the future system states are defined at least by a state parameter and a compressor operating state combination, wherein the state parameter is preferably indicative of a system pressure of the compressor system, wherein values of the state parameter for the at least one future point in time are calculated by simulation based on an initial system state of the compressor system, a future consumption curve of the compressed gas, in particular the compressed air, and a possible compressor operating state combination sequence, wherein a compressor operating state combination indicates in particular a combination of defined possible operating states of the compressors of the compressor system for a future point in time, wherein a compressor operating state combination sequence indicates in particular a time sequence of compressor operating state combinations;
Determining similar system states from the set of future system states determined for a future point in time, wherein the similar system states are each defined by similar values of the state parameter and at least partially matching compressor operating state combinations, wherein similar values of the state parameter are each in the same defined value range, preferably in the same defined pressure value range, of the state parameter;
Reducing the set of system states determined for a future point in time by discarding at least one system state from the set of determined similar system states, in particular based on an evaluation of the compressor operating state combination sequences corresponding to the respective similar system states with respect to a first quality criterion, which is preferably an energy efficiency criterion;
Determining an optimal compressor operating state combination sequence based on an evaluation of those compressor operating state combination sequences which correspond to a system state from the reduced set of system states with respect to a second quality criterion, which is preferably an energy efficiency criterion;
Issuing at least one control command which is suitable for effecting operation of the compressors of the compressor system which corresponds to at least part of the optimum compressor operating state combination sequence.

One idea of the invention is that the computing capacity required to predict the future system behavior of a compressor system is reduced if the number of system states to be considered is reduced by grouping together similar system states. Discarding at least one system state from the set of determined similar system states corresponds to grouping similar system states in that only similar system states that have not been discarded are further considered for the prediction of the future system behavior.

In particular, the method is computer-implemented, wherein the method steps are preferably computer-based, in particular executed by a computer unit (processor). Method steps of determining are based in particular on arithmetic operations and/or comparison operations, and could in this respect be referred to as steps of calculating. Future points in time refer in particular to a time discretization of a predetermined simulation period. The method for controlling (control method) a compressor system can be part of a regulating method for a compressor system, in particular part of a regulating algorithm that regulates at least one system state of the compressor system.

The simulation is based in particular on a (mathematical) model of the compressor system, which depicts the dynamic (time-dependent) behavior of the compressors and preferably other components of the compressor system (e.g. compressed air reservoir, pipelines, valves, oil separator, oil circuit, heat exchanger, etc.). The model can be based on structural modeling of the compressor system, in particular the compressors, modeling of the transitions between the operating states of the compressors, and optionally other components, and/or modeling of the progression of the state parameters over time. The model is preferably based on a (hybrid) system of (time-dependent) equations, in particular non-linear differential equations. In particular, the control method is a model predictive control method (MPC).

In particular, future system states are defined in each case at least by the calculated value of a state parameter for the respective future point in time, wherein the calculated values of the state parameter indicate a calculated future course of the state parameter, which is preferably indicative of the future course of the system pressure. Future system states are in particular (additionally) defined in each case by a compressor operating state combination for the respective future point in time, which indicates the (mechanical) operating state of the compressors. Future system states can (additionally) be defined by further state parameters. Preferably, future system states are defined by the value of a state parameter, the (mechanical) operating state of the compressors and/or the (software-related) state of the control algorithm of the compressor system.

An initial system state is defined in particular by an initial value of the state parameter, which is preferably indicative of the system pressure (e.g. initial system pressure or initial stored gas quantity or air quantity), and in particular by an initial compressor operating state combination. Preferably, a value of the state parameter is calculated by simulation starting from an initial point in time for each future point in time up to the last point in time of the specified simulation period.

The future consumption curve of the compressed gas, in particular the compressed air, indicates in particular the future time curve of the consumption volume flow rate (CVFR(t)) of the compressed gas (compressed air), i.e. preferably the compressed air consumption volume flow rate. The consumption volume flow typically refers to the (atmospheric) ambient pressure. The future consumption can be specified by one or more users of the compressor system (variable over time) or determined by estimation or calculation. Preferably, the future consumption is specified as a (time-dependent) consumption volume flow.

A state parameter, which is indicative of a system pressure of the compressor system, can be a system pressure, in particular in the form of a pressure variable (e.g. unit [bar] or [Pa]), or a state parameter from which a system pressure can be derived, optionally taking into account other parameters, preferably by calculation. For example, the system pressure can be derived from a gas volume (air volume) stored in the compressor system (e.g. unit [m\hat{ }3] or [kg]). In particular, a predetermined pressure range between a predetermined lower pressure limit and a predetermined upper pressure limit for a pressure to be provided by the compressor system has several defined pressure value ranges. The defined pressure value ranges refer in particular to a discretization of the system pressure (pressure discretization) and preferably divide the (entire) pressure range, in particular into disjoint pressure subranges. However, pressure value ranges can also be defined as overlapping. The lower pressure limit and/or the upper pressure limit can be specified variably over time, in particular via software by a user or operator or by (automatic) calculation based on other parameters.

In particular, the defined possible operating states of a compressor indicate at least whether the compressor is running under load (“load”) or not (“no load”). Preferably, the defined possible operating states of a compressor indicate at least whether the compressor is in “standby”, “idle” or “load” mode. For variable-speed compressors, the defined possible operating states of a compressor preferably also specify possible speeds or possible speed ranges.

In particular, a compressor operating state combination specifies a combination of defined possible (discrete) operating states of the compressors of the compressor system for a future point in time. An exemplary compressor operating state combination, in which a first compressor is running under load and a second compressor is not running under load, could be described as “load/no load” (“L/nL”). Another exemplary compressor operating state combination, in which a first compressor is at standstill and a second compressor is idling, could be referred to as “standstill/idle”. In particular, a compressor operating state combination sequence indicates a time sequence of compressor operating state combinations. In particular, a compressor operating state combination sequence specifies a time sequence of combinations of defined possible operating states of the compressors of the compressor system. In particular, a compressor operating state combination sequence comprises a time sequence of several compressor operating state combinations. In this respect, a compressor operating state combination sequence also specifies the (temporal) transitions between the operating states of each compressor. A compressor operating state combination sequence can be understood as the history of the operating states of the compressors underlying a system state. In particular, each compressor operating state combination sequence corresponds to a system state or is assigned to a system state, e.g. in a data structure, and vice versa.

The first quality criterion and/or the second quality criterion is preferably an energy efficiency criterion, in particular a minimum energy consumption (energy efficiency), preferably a minimum total energy consumption (overall energy efficiency). An energy efficiency criterion (overall energy efficiency criterion) preferably relates to electrical energy, thermal energy and/or a fuel quantity and can preferably take into account possible heat recovery (heat recovery). The first quality criterion and the second quality criterion are preferably identical. The quality criterion can (additionally) relate to minimizing the wear of the compressors, in particular with regard to the properties of the mechanics or the oil used for cooling and/or lubrication.

The evaluation of compressor operating state combination sequences with regard to the first and/or second quality criterion is based in particular on a comparison of the energy consumption values with one another, which are calculated based on the respective compressor operating state combination sequences (and other parameters), wherein the lowest energy consumption preferably best fulfils the quality criterion. The optimum compressor operating state combination sequence can be understood in particular as the best possible compressor operating state combination sequence, especially in the sense of the solution found to an optimization problem.

In particular, from the set of system states determined for a future point in time, those system states which are similar are determined as similar system states, wherein the similarity is determined, inter alia, on the basis of a similar value of the state parameter. Determining similar system states from the set of system states determined for a future point in time is preferably based on a comparison of the system states determined for a future point in time with respect to the value of the state parameter (system pressure) with respect to each other and/or with respect to the compressor operating state combinations with respect to each other. Similar values of the state parameter include the same (identical) values of the state parameter. Similar system states can be defined by (completely) matching compressor operating state combinations, wherein deviations with regard to certain defined possible operating states of a compressor can be sufficient for similarity, in particular deviations with regard to speed. Several similar system states can be understood as a group of similar system states, each of which is defined by a similar (or identical) value of the state variable (of the system pressure), in particular by a value of the state variable (of the system pressure) in the same defined value range (pressure value range). Several groups of similar system states can be determined for a future point in time, wherein each group is defined by values of the state variable (of the system pressure) in the same value range (pressure value range) and the value ranges (pressure value ranges) of the respective groups differ from each other. The set of system states determined for a future point in time need not (any longer) include all system states that can (theoretically) be determined for this point in time, but may in particular have been reduced beforehand, in particular by discarding system states whose value of the state parameter (system pressure) lies outside the pressure range.

Reducing the set of system states determined for a future point in time can be understood as reducing the number of system states considered in the further course of the method, in particular as a step of summarizing similar system states. Preferably, all system states from the set of determined similar system states are discarded, except for the system state that best fulfills the (first) quality criterion. Discarding a system state is implemented in particular as deleting (or overwriting) a variable or data structure representing the system state in a computer memory.

In particular, all compressor operating state combination sequences that correspond to one of the system states from the reduced set of system states are evaluated with regard to the (second) quality criterion. Preferably, the compressor operating state combination sequence that best fulfills the (second) quality criterion is determined as the optimal compressor operating state combination sequence.

Preferably, at least one control command combination is issued, which comprises one control command each for several (all) compressors of the compressor system. In particular, a control command combination comprises one control command for each compressor of the compressor system. The at least one control command issued can comprise a sequence of control commands for the same compressor and/or be part of a control command combination. A control command can mean a change in the operating state of the compressor, in particular a switching process (transition) to another operating state, or the compressor remaining in the current operating state. A control command (control command combination) can be understood as a load command (load command combination) to a compressor (or several compressors). In particular, at least one control command is issued which is suitable for effecting operation of the compressors of the compressor system which corresponds to the first part (in terms of time) of the optimum compressor operating state combination sequence. Preferably, the at least one control command (control command combination) issued is suitable for causing operation of the compressors of the compressor system which corresponds (only) to the (temporally) first compressor operating state combination contained in the optimum compressor operating state combination sequence, which corresponds in particular to the (first) future point in time following the initial point in time.

The method is preferably carried out by a higher-level control unit of the compressor system, which in particular controls several (all) compressors of the compressor system. The compressor system interacts in particular with a higher-level control system (system control). This can be provided directly on or in the compressor system (compressed air system) or specifically assigned to the compressed air system. However, the higher-level control system can also control other technical systems and components in addition to the compressor system.

However, the method steps can also be carried out distributed over several control and/or computing units. In particular, the method steps up to the output of the control command can be carried out by at least one (external) computing unit, in particular at least one processor of an (external) server, for example of the operator or manufacturer of the compressor system, and (only) the output of the control command can be carried out by a (higher-level) control unit of the compressor system.

On the one hand, the invention is based on the realization that when calculating a state parameter that changes dynamically in the future, a higher temporal resolution enables a more accurate forecast of the course of the state parameter. On the other hand, it was recognized that the longest possible forecast period (simulation period) of the state parameter enables the earliest possible reaction to the future course of the state parameter. However, a high temporal resolution and a long forecast period simultaneously increase the required computing capacity. Furthermore, it is recognized that available computing capacities are not sufficient if all possible sequences of control commands for each compressor (e.g. load command: “load” or “no load”) and/or other components of the compressed air system are to be considered in a sufficiently long simulation period with sufficient time resolution for the control of a compressed air system with one or more compressors, since the number of possible sequences of control commands (load commands) to be considered and their combinations for several compressors increases exponentially with the number of time steps. For example, a simulation period of 600 seconds (10 minutes) with a time resolution of 1 second results in 4\hat{ }600=1.72*10\hat{ }361 different possible sequences of control commands for a combination of two compressors with a fixed speed. It is not possible to determine the optimum sequence of control commands in real time due to the dimensions of the solution space. A reduced temporal resolution is not sufficient for the mapping of (highly) dynamic processes that may be required. The simulation period cannot be shortened arbitrarily either if the control of the compressed air system is to take future events into account as early as possible. Although reducing the time resolution in the example mentioned to 60 seconds (1 minute) reduces the number of control command sequences for a simulation period of 10 minutes to 4\hat{ }10=1,048,576, such a reduction in the time resolution would not be practically applicable for the control of compressors in compressed air systems, as relevant dynamic processes in compressed air systems typically have time constants in the order of seconds. A high temporal resolution and a sufficient simulation period are necessary for a reliable prediction of state variables.

The method according to the invention ensures the best possible operation of the compressor system, specifically the optimal operation with regard to a quality criterion. Compared to the prior art, a longer forecast period of the system state (simulation period) can be achieved, which makes it possible to output the optimum control command under the given boundary conditions at an earlier stage. At the same time, dynamic influences and/or processes in the compressor system can be taken into account more accurately thanks to a high temporal resolution.

In one embodiment of the method, the state parameter specifies a system gas volume, in particular system air volume, stored in the compressor system. In particular, the system pressure can be derived from the system gas volume, in particular based on the buffer volume of the compressor system. The (effective) buffer volume of the compressor system is determined in particular by the (total) gas-storing (air-storing) volume of the compressor system, in particular from the inlet (air inlet) to the consumer (compressed air consumer), and includes in particular the volumes of the compressed air tank, the compressed air lines and any other type of compressed air-storing components (oil separator, etc.). The stored system gas volume (system air volume) as a state parameter enables simple calculation of the state parameter, in particular by calculating the difference between a delivery volume flow supplied by the compressors and a consumption volume flow withdrawn by the consumer, in particular based on an initial stored system gas volume. The buffer volume determines the extent to which differences between a delivery volume flow of the compressors and a consumption volume flow result in a change in the system pressure. The larger the buffer volume, the smaller the pressure change (all other things being equal).

One embodiment comprises the method step of discarding those system states determined for a future point in time which are indicative of a system pressure which lies outside a predetermined pressure range for a pressure to be provided by the compressor system, in particular above the predetermined upper pressure limit or below the predetermined lower pressure limit. This method step can be carried out as an additional process step, in particular before the method step of determining the similar system states. Discarding a system state is implemented in particular as deleting (or overwriting) a variable or data structure representing the system state in a computer memory. In this way, system states that do not fulfill the boundary conditions for the system pressure and the corresponding compressor operating state combination sequences can be excluded as early as possible in the method in order to avoid wasting computing capacity.

One embodiment comprises the method step of determining further future system states of the compressor system by calculating the state parameter for at least one further future point in time by simulation, in each case based on the initial system state of the compressor system and a further possible compressor operating state combination sequence, wherein a compressor operating state combination sequence which corresponds to a system state from the limited set of system states of a preceding future point in time is part of the further possible compressor operating state combination sequence. This method step is preferably carried out after the set of system states determined for a future point in time has been reduced. This ensures that further future system states are only determined on the basis of those previous future system states whose compressor operating state combination sequence can be considered for selection as the optimum compressor operating state combination sequence. In this way, computing capacity can be saved.

In one embodiment, future system states of the compressor system are determined for the future points in time contained in a predetermined simulation period, wherein the simulation period is divided into equidistant time steps. A time step is preferably between 0.1 s and 10 s. The simulation period is in particular more than 1 min, preferably between 1 min and 60 min. The time step is in particular the interval between two consecutive points in time. By reducing the number of system states to be calculated by the simulation, computing capacity can be saved. Consequently, smaller time steps can be selected compared to the prior art. In particular, the (relatively small) time steps can be selected to be constant (equidistant) over the simulation period. This ensures a high temporal resolution in every area of the simulation period. The simulation period could also be calculated, in particular based on an (estimated) remaining time available until the next time step. The remaining time may depend on the computing speed of a computer on which the simulation is executed. This procedure could be referred to as determining an adaptive simulation period. In this way, the real-time capability of the control method can be guaranteed.

One embodiment comprises, as a method step, the cyclical rejection of the system states determined for a future point in time based on the first quality criterion and/or the second quality criterion, in particular after a defined number of time steps (cycle). In particular, a time step specifies the interval between two successive points in time. This method step is carried out in particular in addition, namely preferably after reducing the set of system states determined for a future point in time by discarding at least one system state from the set of determined similar system states, preferably several times during the specified simulation period, for example every 5 to 25 time steps. Preferably, those system states determined for a future point in time which fulfill the first and/or second quality criterion less well than the other system states determined for this point in time are discarded. For example, only the best 10-50% of the system states determined for a future point in time in terms of the quality criterion are considered further and the remaining system states are discarded. By cyclically reducing the system states, the number of system states to be considered can be reduced and computing capacity can be saved.

In one embodiment, the future system states are mapped by a branched data structure in a computer memory, preferably by repeated execution of process steps, wherein a future system state corresponds to a node of the branched data structure and the branched data structure comprises several node levels, wherein future system states determined for a future point in time are each assigned to the same node level. A node can be mapped as a data structure (data object, e.g. as a class) in a computer memory and thus be referred to as a node data structure. Discarding a system state can be understood as deleting the nodes corresponding to the system state (node data structure). Preferably, further nodes (node data structures) are generated (recursively) by determining further future system states of the compressor system by calculating the state parameter for at least one further future point in time by simulation, in each case based on the initial system state of the compressor system and a further possible compressor operating state combination sequence. It is not necessary for new nodes (node data structures) to be generated on the next node level for each node of a node level in the next time step. For example, a certain compressor operating state combination could be maintained over several time steps, especially when the compressor is at a standstill. In particular, the branched data structure is generated by an algorithm using a so-called branch-and-bound method. The branched data structure can be understood as an implementation of a tree that maps a hierarchical structure, which can be generated in particular by a recursive loop.

In one embodiment, the at least one control command is issued when the future system states of the compressor system are determined for the future points in time contained in a predetermined simulation period and the optimum compressor operating state combination sequence is determined. The at least one control command issued is in particular a control command combination for several (all) compressors of the compressor system, which preferably comprises a control command for each compressor of the compressor system. This determines the optimum compressor operating state combination sequence, taking into account the entire specified simulation period. Depending on the length of the specified simulation period, the control command issued reacts to the calculated future course of the state parameter at an appropriately early stage. The control command issued at the current real time causes the (currently) best possible operation of the compressor system with regard to the entire specified simulation period relating to the future.

In one embodiment, the at least one issued control command, preferably the at least one issued control command combination, corresponds to the transition from the compressor operating state combination corresponding to the initial system state to that compressor operating state combination corresponding to the subsequent future system state, which is part of the optimal compressor operating state combination sequence. In particular, the control command combination issued (only) causes the implementation of the first compressor operating state combination (in terms of time) of the optimum compressor operating state combination sequence in the compressor system, i.e. the corresponding operation of the compressors. At the end of a process run, i.e. in particular after determining the future system states for the entire simulation period (i.e. from the initial point in time to the last time step) and determining the optimum compressor operating state combination sequence, preferably only the first compressor operating state combination of the entire optimum compressor operating state combination sequence is implemented by a (single) control command combination. A further process run can then be started with the next future point in time as the initial point in time with the simulation period shifted back accordingly (by one time step) to output the next control command combination.

In one embodiment, the evaluation with regard to the first quality criterion and/or the second quality criterion is based on a calculated energy consumption of the compressors when passing through a compressor operating state combination sequence from the initial point in time to the respective point in time. The optimum compressor operating state combination sequence is, in particular, the compressor operating state combination sequence which has the lowest calculated energy consumption of the compressors.

In one embodiment, at least one of the following parameters is included in the calculation of the energy consumption:
a switching energy for starting a compressor;
a switching energy for the pressure build-up of a compressor;
a switching energy for the pressure reduction of a compressor;
an idle power of a compressor;
a load capacity of a compressor, in particular a pressure-dependent load capacity.

In particular, the parameters include stored specification data for the respective compressors. Further parameters can be included in the calculation of the energy consumption, which in particular take into account the energy consumption of other components of the compressor system. In particular, the energy consumption indicates the consumption of electrical energy and/or the consumption of fuel. The optimum compressor operating state combination sequence determined for the future points in time at the end of the specified simulation period is, in particular, an optimum compressor operating state combination sequence in terms of energy consumption over the entire simulation period. Accordingly, the compressor system can be operated with the greatest possible energy efficiency.

In one embodiment, the evaluation with respect to the first quality criterion and/or the second quality criterion takes into account a possible heat recovery, in particular for heat transfer to a, preferably external, heat consumer. In particular, the possible heat recovery is determined by calculating an amount of heat recoverable from an oil circuit (100) of the compressor system (heat output) and/or by calculating an amount of heat recoverable from a compressed gas flow, preferably compressed air flow. In the latter case, the amount of heat is preferably recoverable from the compressed air flow by intercooling and/or aftercooling. The recoverable amount of heat can be stored in the oil of the oil circuit or in the compressed gas flow (compressed air flow), in particular as compression heat. In principle, other forms of recoverable compressor waste heat can also be taken into account. The recoverable amount of heat (heat output) can be modelled using analytical equations or implemented using an optimization based on a metamodel. An external heat consumer can be understood as a heat consumer that is not part of the compressor system, for example a room to be heated or an (industrial) process based on heat supply.

In one embodiment, the calculation of a recoverable amount of heat (heat output) is based on at least one of the following parameters:
a temperature of the oil in an oil circuit of the compressor system;
the ambient temperature of the compressor system;
a flow rate of the oil in an oil circuit of the compressor system;
a final compression temperature of the compressed gas, in particular the compressed air;
a specified or calculated heating energy of a compressor;
a specified or calculated cooling energy of a compressor.

The parameters can include measured variables, calculated values or stored specification data of the compressors and/or compressor system.

The calculation of a recoverable amount of heat (heat output) can include the calculation of the amount of heat that can be transferred in an oil/air heat exchanger and/or at an oil/water heat exchanger of the compressor system from the oil circuit of the compressor system (directly or indirectly) to a heat utilization circuit (heating circuit) with a heat transfer medium (air or water). Preferably, the calculation is based on a temperature of the oil in an oil circuit of the compressor system, the ambient temperature of the compressor system and/or a flow rate of the oil in an oil circuit of the compressor system.

Alternatively or additionally, the calculation of a recoverable amount of heat (heat output) can include the calculation of the amount of heat that can be transferred in a gas/air (air/air) heat exchanger of the compressor system from a gas flow (compressed air flow) compressed in the compressor system to a heat utilization circuit (heating circuit) with a heat transfer medium (air). In particular, but not only, in the case of oil-free compressors (dry-running compressors), the compression heat stored in the compressed air can be transferred to a heat transfer air flow for heat utilization by intermediate cooling in an (air/air) heat exchanger after a first compression stage and/or by post-cooling after a second compression stage in an (air/air) heat exchanger. Preferably, the calculation is based on the ambient temperature of the compressor system and/or a final compression temperature of the compressed gas, in particular the compressed air.

In particular, the heat stored in the oil circuit of the compressor system and/or in a compressed gas flow (compressed air flow) is determined based on a compressor operating state combination sequence. Continued (prolonged) operation of a compressor, preferably over several time steps, in a heat-generating operating state, in particular in idling or load run, can be favorable with regard to an energy efficiency criterion, taking into account possible heat recovery. In particular, a compressor operating state combination sequence that corresponds to the continuation of the energy-consuming operation of a compressor in idling (or load running) can be more favorable overall in terms of energy with regard to a possible heat recovery of the amount of heat stored in the oil circuit and/or in the compressed gas flow (compressed air flow) than a compressor operating state combination sequence that corresponds to the change in the operating state of the compressor due to the transition from idling to standstill (or the transition from load running to idling), even though the compressor consumes less energy when idling. The consideration of a possible heat recovery enables the selection of the optimum compressor operating state combination sequence in terms of overall energy efficiency and the issuing of a corresponding control command combination and thus the most energy-efficient operation of the compressor system overall.

In one embodiment, the defined possible operating states of a compressor indicate, preferably additionally, at least one rotational speed of the compressor, wherein preferably different rotational speeds or rotational speed ranges each correspond to a defined possible operating state. Defined possible operating states of a compressor preferably specify a speed as a (percentage) share of the maximum speed of the compressor. Different possible operating states can be defined for different compressors, preferably for each compressor type. The compressor system can comprise fixed-speed and variable-speed compressors. The consideration of different operating states of variable-speed compressors as (additional) defined possible operating states allows the determination of an optimum compressor operating state combination sequence that takes into account the technical possibilities of variable-speed compressors in modern compressor systems. The output of corresponding control commands for variable-speed compressors utilizes the functional scope of these compressors for the best possible operation of the compressor system.

In one embodiment, the future system states are further defined by at least one, in particular software-related, control state parameter, which in particular indicates the state of the control algorithm of the compressor system. Preferably, the control state parameter indicates the previous operating time of a compressor in the same defined possible operating state. In particular, two system states of a compressor are similar with regard to the (software-related) control state parameter if the time since the compressor has been idle is similar (or the same). The similar system states are preferably each defined by similar values of the state parameter, by a matching compressor operating state combination and by at least one matching control state parameter. This ensures that only those similar system states are discarded that are sufficiently similar with regard to the technical state description that is relevant for the technically actual possible transition from one future point in time to the next point in time.

In one embodiment, permissible transitions between successive defined possible operating states of a compressor are defined, wherein, preferably additionally, transition conditions are defined for at least one specific transition of a compressor between two defined possible operating states, in particular for the transition of a compressor from idling to standstill and/or from idling to load running. Preferably, the compressor must be operated in idle mode for a predetermined first minimum running time before the transition from idle mode to standstill and/or preferably, the compressor must be operated in idle mode for a predetermined second minimum running time before the transition from idle mode to load mode. In particular, the first minimum idling time prevents the oil from foaming up when the compressor is switched to standstill. In particular, the second minimum running time ensures sufficient time for the pressure to build up. Preferably, a (direct) transition from load run to standstill is not possible. In particular, a compressor must first be switched from load run to idle operation, preferably for the specified first minimum running time. Preferably, only defined transitions between certain speeds or speed ranges are possible.

In one embodiment, a transition condition can be provided for the transition of a compressor from load run to standstill, in particular for compressors for which operation in idle mode is not possible. Compressors can only have two defined possible operating states (standstill and load run). The transition condition can be that a minimum load running time must not be exceeded before a compressor is switched off. This can ensure that a motor winding temperature of the compressor does not exceed a temperature limit value. Especially when starting up from standstill, high motor currents occur which cause the motor winding temperature to rise. Before (re)switching to standstill, a minimum load running time can be provided as a transition condition so that the motor windings can cool down before switching off. This ensures that the compressor, or its cooled motor, can be restarted at any time without the motor windings overheating. This guarantees that the compressor can be switched to all defined possible operating states without being damaged.

By defining permissible transitions between defined possible operating states, the method takes into account the actual technical behavior of the compressor system and can also guarantee safe operation under all circumstances.

In one embodiment, at least one of the following parameters is included in the determination of the future system states:
a buffer volume of the compressor system, wherein the buffer volume indicates in particular the volume of the compressor system in which compressed gas, in particular compressed air, is stored during operation;
a, in particular pressure-dependent, delivery volume flow of a compressor;
a, in particular time-dependent, consumption volume flow of the at least one consumer;
the ambient pressure.

The parameters can include measured variables, calculated values or stored specification data of the compressors and/or compressor system as well as parameters specified by users, preferably via software.

In particular, the consumption volume flow indicates the (time-dependent) course of the (future) consumption of compressed gas, especially compressed air (compressed air consumption). The consumption volume flow can be specified (variable over time) or determined by estimation or calculation. The ambient pressure is in particular the ambient pressure of the compressor system.

In one embodiment, the steps of the method are carried out repeatedly one after the other starting from different initial points in time in several method executions, wherein in particular the compressor operating state combination of the optimum compressor operating state combination sequence of the previous method execution corresponding to the first future point in time is used as the compressor operating state combination of the subsequent method execution corresponding to the initial point in time. In particular, successive executions of the method are each carried out with the current real time as the initial time. Alternatively, a further execution of the method could use the current real (e.g. measured) system state of the compressor system as the initial system state for the next simulation. Preferably, the end of the (fixed) predetermined simulation period is continuously shifted into the future when the method is carried out repeatedly. The duration of the simulation period can be specified to vary. In particular, the method enables the output of a control command (control command combination) in real time.

The said object is also solved in particular by a control unit for a compressor system comprising a plurality of compressors for generating compressed gas, in particular compressed air, for at least one consumer, wherein the control unit is designed to carry out at least one step, preferably the steps, of the method according to the invention. The control unit is in particular a higher-level control unit of the compressor system, which in particular controls several (all) compressors and preferably other components of the compressor system. The control unit can (only) carry out the issuing of the at least one control command, while the other method steps are carried out on a server, for example of the operator or manufacturer of the compressor system, which is in communicative connection with the control unit.

The said object is also solved in particular by a compressor system comprising a plurality of compressors for generating compressed gas, in particular compressed air, for at least one consumer and a control unit according to the invention.

The said object is also solved in particular by a computer program comprising instructions which, when executed on at least one processor, cause the processor to carry out the steps of the method according to the invention. In particular, the instructions cause the control unit according to the invention to carry out at least one step, preferably the steps, of the method according to the invention.

The said object is also solved in particular by a computer-readable storage medium on which the computer program according to the invention is stored. The storage medium can comprise a plurality of storage media, which can be distributed over different computing units, in particular those of a control unit and those of a server.

The control unit, the compressor system, the computer program and the computer-readable storage medium have similar advantages to those already described in connection with the method according to the invention.

The invention is explained in more detail below with reference to the drawings, which show as follows:

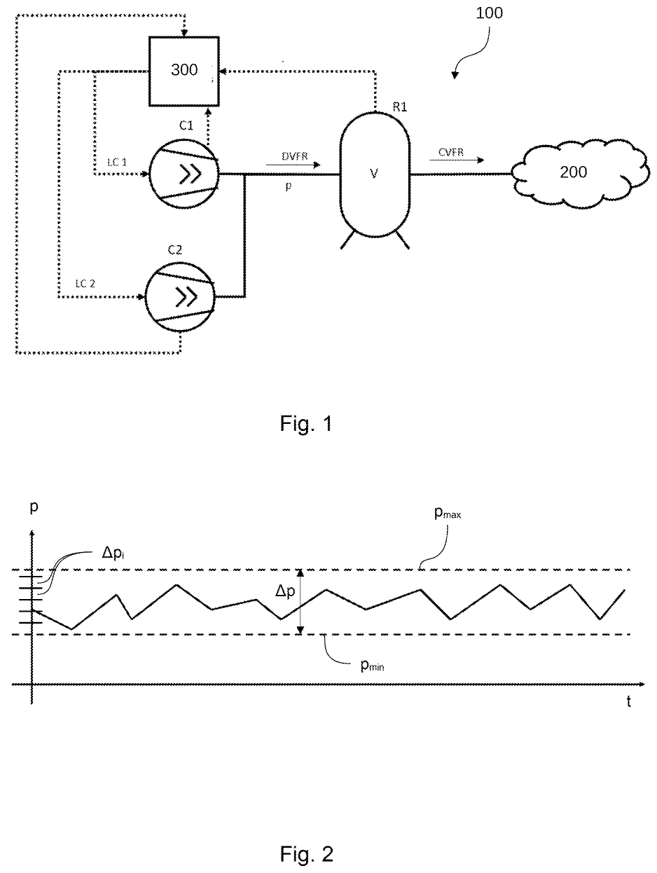

FIG. 1 shows a schematic representation of an embodiment of a compressor system having several compressors and a control unit, which is designed to carry out the method;

FIG. 2 shows an exemplary representation of the time sequence of a state parameter that is indicative of the system pressure;

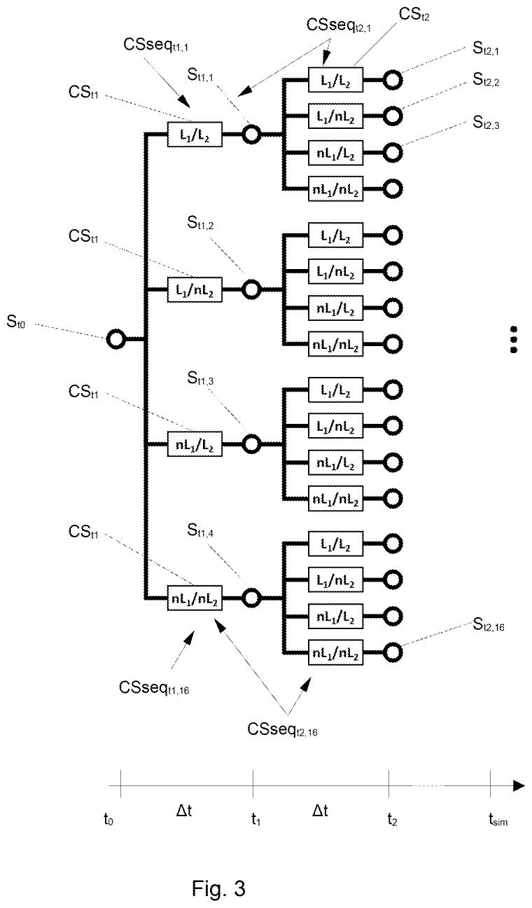

FIG. 3 shows an illustration of future system states for several compressors of the compressor system in the time sequence of an embodiment of the method;

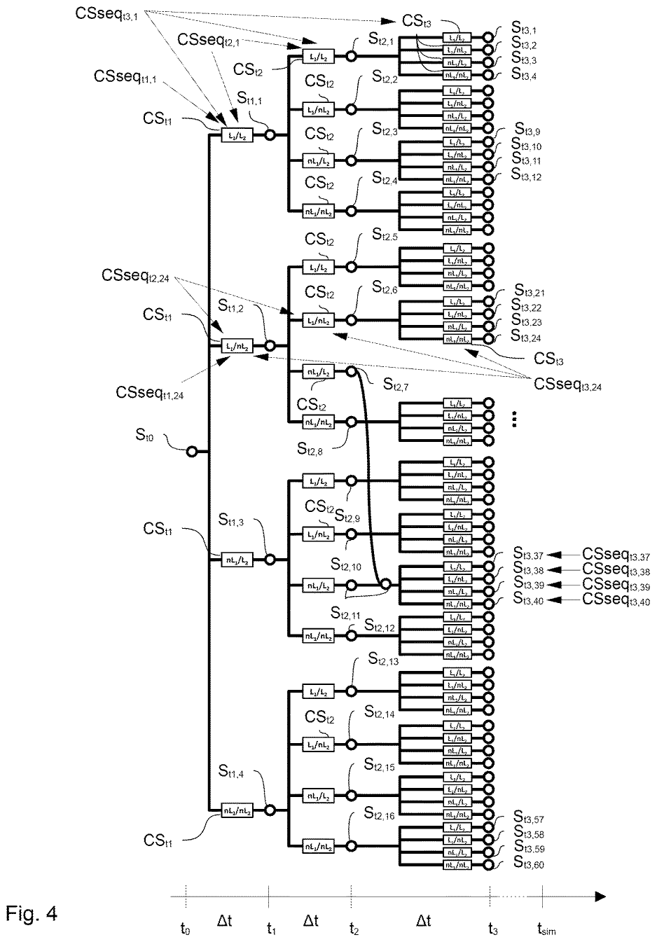

FIG. 4 shows an illustration of future system states of the compressor system with several compressors in the time sequence of the method;

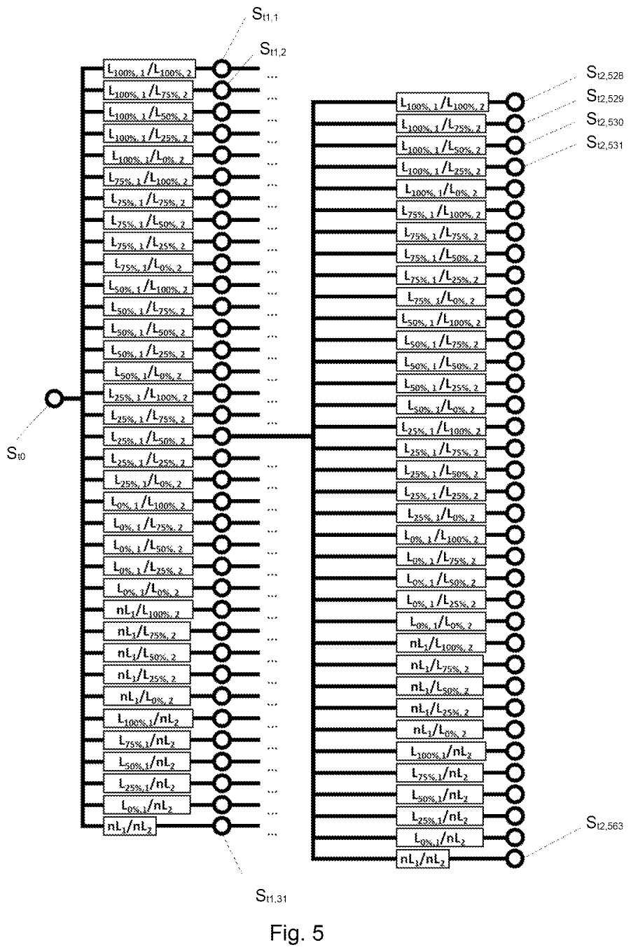

FIG. 5 shows an illustration of future system states of the compressor system with several variable-speed compressors in the time sequence of a further embodiment of the method;

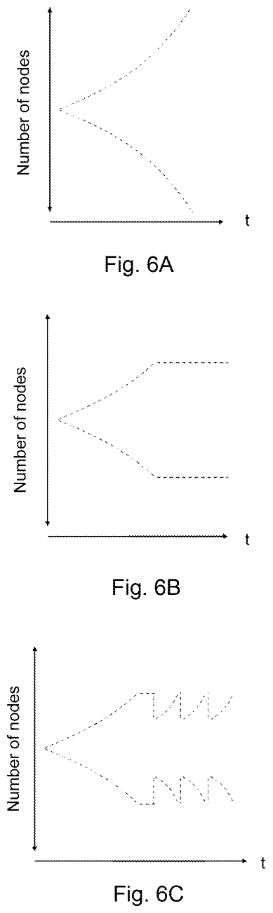

FIGS. 6A-C show a comparison of two embodiments of the method (FIGS. 6B and 6C) with a brute force approach from the prior art (FIG. 6A);

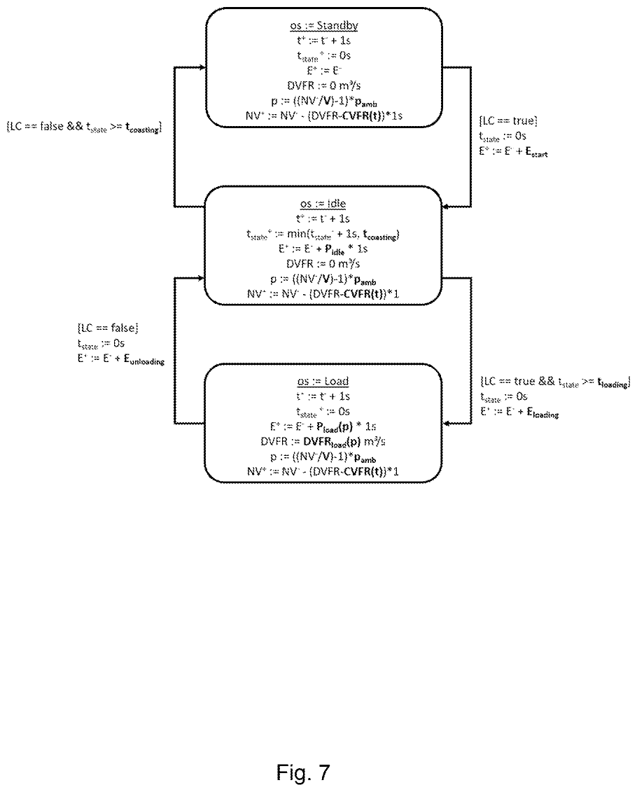

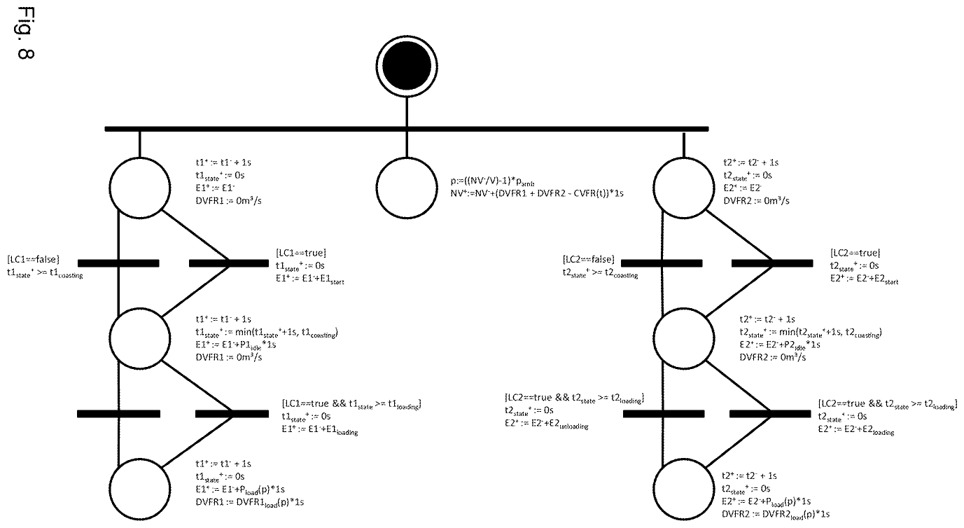

FIG. 7 shows a representation of the determination of future system states according to one embodiment of the method as a hybrid automaton;

FIG. 8 shows a representation of the determination of future system states according to one embodiment of the method as a Petri net;

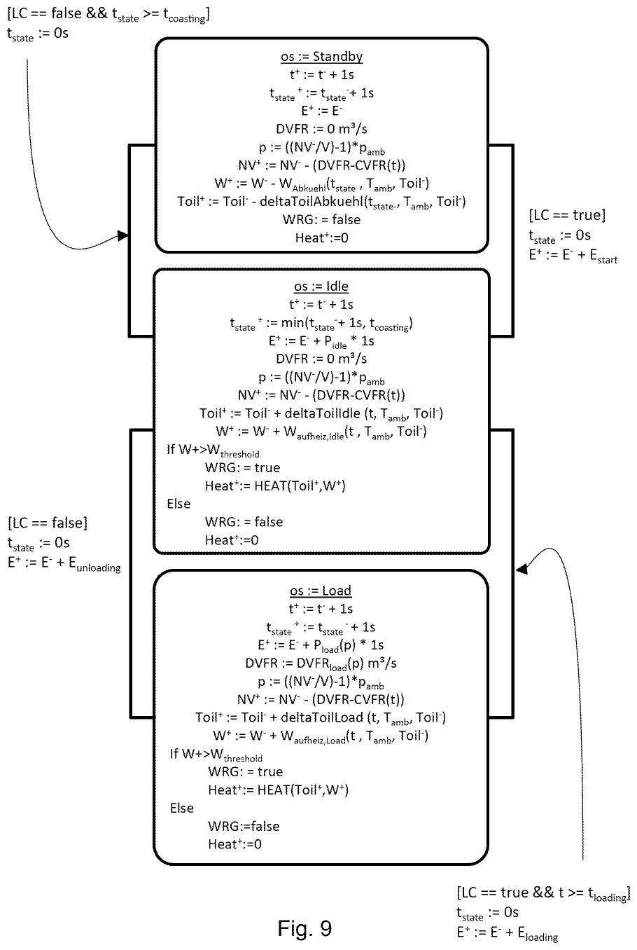

FIG. 9 shows a representation of the determination of future system states according to one embodiment of the method with possible heat recovery as a hybrid automaton.

In the following description of the invention, the same reference signs are used for identical and identically acting elements.

FIG. 1 shows an example of a compressor system 100 according to the invention having a plurality of compressors for generating compressed air for the consumer 200. In the present case, two compressors C1, C2 are present (two-compressor compressed air station), which are connected via pipelines to the compressed air reservoir R1 and further to the consumer 200, wherein several consumers can be connected. The compressor system 100 can comprise further compressors and additional components of a compressed air system, such as filters, dryers or valves. Compressor systems with oil-injected compressors typically comprise an oil circuit for cooling and/or lubricating the compressors as well as an oil separator tank. There may also be at least one heat exchanger for recovering heat from the oil circuit. At least one heat exchanger for recovering heat from the compressed air flow may also be provided.

A control algorithm is executed on the control unit 300 according to the invention, which outputs a respective control command (load command) LC1, LC2 to the compressors C1, C2. The combination of both control commands LC1, LC2 represents a control command combination LC1/LC2, which can also be referred to as a load command combination. The control algorithm uses the control commands (load commands) LC1 and LC2 to specify when a compressor C1 or C2 should supply compressed air (control command: “load”) or not (control command: “no load”), taking into account the system pressure p in the compressed air reservoir R1. The operating status of a compressor indicates whether the compressor is running under load (“load”) or not under load (“no load”), i.e. at standstill or idle. The control algorithm knows the operating states and the technical characteristics of the compressors C1, C2 and can therefore determine the delivery volume flow rate (DVFR), which is typically pressure-dependent (DVFR(p)). The consumer volume flow rate (CVFR) required by the consumer 200, which is typically time-dependent (CVFR(t)), is taken from the compressed air reservoir R1. The difference between DVFR and CVFR determines how the system air volume NV stored in the buffer volume V of the compressor system 100 changes. The buffer volume V comprises the total air storage volume of the compressor system 100, which is primarily indicated here by the volume of the compressed air reservoir R1. The system pressure p is derived from the stored system air volume NV and the buffer volume V. In this respect, the stored system air volume NV, specifically the air volume stored in the compressed air reservoir R1, is indicative of the system pressure.

FIG. 2 shows an exemplary curve of the system pressure p as a state parameter of the system state of the compressor system over time t. The pressure to be provided by the compressor system 100 for the consumer 200 should always lie within a specified pressure range Δp between a lower pressure limit pₘᵢₙ and an upper pressure limit pₘₐₓ, which can also change over time.

In the method according to the invention, the future course of the state parameter, which is indicative of the system pressure p, is calculated by simulation. For this purpose, the time t is divided into, preferably equidistant, time steps Δt between two successive future points in time tₙ, tₙ₊₁ (Δt=tₙ₊₁−tₙ) over a predetermined simulation period tₛᵢₘ (time discretization). The simulation period tₛᵢₘ corresponds to a forecast period for the state parameter. Values of the state parameter are calculated starting from an initial system state Sₜ₀ at the initial time t₀ based on a mathematical model that maps the dynamic behavior of the compressor system 100. A time step Δt is preferably between 0.1 s and 10 s, wherein the simulation period tₛᵢₘ is in particular more than 1 min, preferably between 1 min and 60 min.

In the method, the pressure range Δp is divided into several defined pressure value ranges Δpᵢ (pressure discretization), wherein a pressure value range Δpᵢ preferably extends over a value range between 0.005 bar and 0.1 bar, for example over 0.02 bar. The pressure value ranges Δpᵢ are used to determine similar system states S_{tn,sim}. Similar system states S_{tn,sim} are defined by similar values of the system pressure p insofar as the values of the system pressure p are each in the same defined pressure value range Δpᵢ.

The control task of the method carried out on the control unit 300 is to control the compressors C1, C2 by means of suitable control commands LC1, LC2 in such a way that the consumption of compressed air required by the consumer can be covered, wherein the system pressure is maintained in particular within the pressure range Δp, and the compressor system 100 is operated as efficiently as possible, in particular energy-efficiently, i.e. the energy consumption E is minimized. The determination of the energy consumption E takes into account at least the electrical power consumed by the compressors C1, C2, in particular the idle power P_{idle} and the pressure-dependent load power P_{load}(p), and is described below.

In a cyclical execution of the method, preferably in each time step Δt, an optimum sequence of operating states of the multiple compressors C1, C2 (optimum compressor operating state combination sequence CSseqₒₚₜ,) is determined over the simulation period tₛᵢₘ, which corresponds to a sequence of control commands (load command sequence) that could bring about this sequence of operating states of the compressors C1, C2. For this purpose, the future course of a state parameter indicative of the system pressure p, preferably the stored system gas quantity NV, specifically the system gas volume, is determined by simulation for future time steps tₙ, wherein no possible compressor operating state combination sequences CSseq_{tn,m} are excluded from the outset. The future consumption of compressed air is estimated and specified as the future consumption volume flow CVFR(t). In particular, the calculated values of the system pressure p comply with the specified pressure range Δp between the lower pressure limit pₘᵢₙ and the upper pressure limit pₘₐₓ. At least a first part of the optimum compressor operating state combination sequence CSseqₒₚₜ is implemented by issuing at least one control command LC1, LC2 to control the real compressor system 100. In this way, the method finds the optimum solution for controlling the compressor system.

In preferred embodiments of the method, the configuration of a tree structure consisting of nodes and node connections is used to examine the solution space of all (theoretically) possible compressor operating state combination sequences CSseq_{tn,m}, or corresponding control command sequences (load command sequences), which is necessary as part of the optimization. Such tree structures, or more precisely parts thereof, are shown in FIGS. 3 to 5. The nodes correspond to the system states S_{tn,m} of the compressor system 100 and the node connections correspond to the control commands LC1, LC2 or control command combinations LC1/LC2 for the transition between the system states S_{tn,m}. When building the tree structure, similar and invalid system states S_{tn,m} can be discarded at an early stage (“pruning the tree”) in order to reduce the number of nodes or system states to be considered and thus save computing capacity.

By discarding system states S_{tn,m}, preferably as early as possible, the number of computationally intensive simulations to be carried out to calculate the future course of the state parameter can be reduced to such an extent that solving the described optimization problem with the computing capacities available today is even possible for a sufficiently long forecast period with sufficiently accurate time discretization. In particular, this allows a real-time capable method to be achieved.

of the tree structure is reduced to such an extent that it is possible to examine the tree structure in real time to find the optimum path over the forecast horizon (corresponds to the optimum load command sequence).

In the embodiment described, the method according to the invention comprises the following steps:

In a first step, several future system states S_{tn,m} (hereinafter often simplified: system states S_{tn,m}) of the compressor system 100 are determined for at least one future point in time tₙ. The future system states S_{tn,m} are defined at least by a state parameter and a compressor operating state combination CSₜₙ, wherein the state parameter is indicative of a system pressure p of the compressor system 100. Values of the state parameter are calculated for the at least one future time tₙ by simulation based on an initial system state Sₜ₀ of the compressor system 100, a future consumption of compressed air and a possible compressor operating state combination sequence CSseq_{tn,m}.

In a second step, similar system states S_{tn,sim} are determined from the set of future system states Sₜₙ determined for a future time tₙ. The similar system states S_{tn,sim} are each defined by similar values of the state parameter and at least partially matching compressor operating state combinations CSₜₙ. Similar values of the state parameter are each in the same defined value range, namely in the same defined pressure value range Δpᵢ, of the state parameter.

In a third step, the set of system states Sₜₙ determined for a future time tₙ is reduced by discarding at least one system state from the set of determined similar system states S_{tn,sim}. This is carried out based on an evaluation of the compressor operating state combination sequences CSseq_{tn,m} corresponding to the respective similar system states S_{tn,sim} with regard to a first quality criterion, which is an energy efficiency criterion.

In a fourth step, an optimal compressor operating state combination sequence CSseqₒₚₜ is determined based on an evaluation of those compressor operating state combination sequences CSseq_{tn,m} that correspond to a system state from the reduced set of system states Sₜₙ with respect to a second quality criterion, which is the same energy efficiency criterion.

In a fifth step, at least one control command LC1, LC2 or a control command combination LC1/LC2 is issued which is suitable for causing an operation of the compressors C1, C2 of the compressor system 100 which corresponds to at least a part of the optimum compressor operating state combination sequence CSseqₒₚₜ.

A compressor operating state combination CSₜₙ indicates a combination of defined possible operating states of the compressors C1, C2 of the compressor system 100 for a future time tₙ. A compressor operating state combination sequence CSseq_{tn,m} specifies a time sequence of compressor operating state combinations CSₜₙ.

FIGS. 3 to 5 each illustrate a set of future system states S_{tn,m}, which are shown in a tree structure.

A tree structure is implemented in particular as a branched data structure and is preferably generated by an algorithm using a so-called branch-and-bound method. The tree structure represents a hierarchical structure that can be generated in particular by a recursive loop. The future system states S_{tn,m} are mapped by a branched data structure in a computer memory, wherein a future system state S_{tn,m} corresponds to a node and the branched data structure comprises several node levels. A node is stored as a data structure (node data structure). Each node level corresponds to a future point in time tₙ of the time discretization. The future system states (Sₜₙ) determined for a future point in time (tₙ) are each assigned to the same node level. Starting from a root node (initial system state Sₜ₀), the tree structure (branch) branches out over several levels (node levels) of interconnected nodes (future system states S_{tn,m}) further and further up to the end nodes, which here lie in the node level corresponding to the time of the end of the specified simulation period tₛᵢₘ.

A tree structure can be used to map a discrete number of combinatorial possibilities (combinations). The nodes (future system states S_{tn,m}) of the tree structure span the solution space in which an (optimal) solution can be found. By checking suitable bounds, suboptimal combinations can be excluded at an early stage. The size of the tree structure (number of nodes), and thus the combinations to be run through, is thus efficiently limited.

In the method according to the invention, of the system states Sₜₙ of a node level determined for a future time tₙ, similar system states S_{tn,sim} are determined and only the system state which best fulfills a quality criterion is pursued further. The other similar system states are discarded. Discarding a system state S_{tn,m} corresponds to removing the corresponding nodes from the tree structure or combining the corresponding nodes into a single node.

FIGS. 3 to 5 illustrate the method as follows:

A tree structure is built up step by step (from left to right). The tree structure is generated in a computer, preferably as a branched data structure. In the very first time step, starting from the initial time t₀, an initial node is created that corresponds to the initial system state Sₜ₀ and an initial compressor operating state combination CSₜ₀. For subsequent points in time tₙ, nodes are first generated for all possible compressor operating state combinations CSₜₙ. Each compressor operating state combination CSₜₙ corresponds to an associated load command combination (control command combination) that can cause the respective compressor operating state combination CSₜₙ. The entire path from the initial node along the node connections to the respective node in the node level at time tₙ corresponds to a possible compressor operating state combination sequence CSseq_{tn,m}.

FIG. 3 shows the generation of the tree structure using three consecutive points in time t₀, t₁ and t₂ for the two compressors C1, C2. At each point in time tₙ, compressor 1 can be switched to load (L₁) or no load (nL₁) and compressor 2 can be switched to load (L₂) or no load (nL₂). This results in a corresponding load command combination for each node. Possible load command combinations are made up of a load command (L₁ and L₂) or no-load command (nL₁ and nL₂) for the two compressors, i.e. for example the load command combination “L₁/nL₂” for the first compressor C1 in load and the second compressor C2 not in load (i.e. standstill or idle). FIG. 4 shows a corresponding tree structure for four consecutive points in time t₀, t₁, t₂, and t₃.

Each node corresponds to a future system state S_{tn,m} of the compressor system. The respective system state S_{tn,m} is determined for each node based on the corresponding compressor operating state combination sequence CSseq_{tn,m}. At the point in time t₂, future system states S_{t2,1} to S_{t2,16} are carried out, for example, based on the operating state combination sequences CSseq_{t2,1} to CSseq_{t2,16} (see FIG. 3). The stored system air volume NV is calculated as a state parameter and is indicative of the system pressure p, which is derived from it. In each case after the extension of the tree structure by the nodes of an additional time step tₙ₊₁, further future system states S_{tn+1,m} are determined, for which purpose simulations are carried out to calculate the state parameter based on the compressor operating state combination sequences CSseq_{tn+1,m}.

A simulation model is used to determine the system states S_{tn,m}, which is shown in a simplified form in FIG. 7 and in an alternative form in FIG. 8, both for one compressor. A simulation model extended to take into account possible heat recovery is shown in FIG. 9. Due to the use of a mathematical model to map the dynamic behavior of the compressor system for calculating the future behavior of the compressor system, the method can be described as a model predictive control (MPC) method.

When generating the tree structure, future system states S_{tn,m} or the corresponding compressor operating state combination sequences CSseq_{tn,m}, which cannot be part of the optimal solution and are therefore “invalid”, are preferably discarded as early as possible. In other words, the tree structure is “pruned” at the corresponding node. In particular, those system states S_{tn,m} whose value for the state parameter is outside the specified pressure range Δp for the pressure to be provided by the compressor system 100, specifically above the specified upper pressure limit pₘₐₓ or below the specified lower pressure limit pₘᵢₙ, are discarded as early as possible. As a result, the corresponding node can no longer be used as a starting point for the extension of the tree structure, i.e. for the continuation of the corresponding compressor operating state combination sequence CSseq_{tn,m} to the next point in time tₙ₊₁. This considerably reduces the number of possible solutions in the solution space, as no simulations need to be carried out for the potential future system states S_{tn+1,m} resulting from the discarded system state S_{tn,m}.

In order to further counteract the fundamental problem of exponential growth of the solution space (see FIG. 6A), similar system states S_{tn,sim} are determined, specifically classified as similar by comparing them with each other. Nodes that represent a similar system state S_{tn,sim} with regard to the technical state of the compressor system are combined into one node, which means that only one system state Sₜₙ of the similar system states S_{tn,sim} is retained and the others are discarded. This procedure of reducing the set of system states S_{tn,m} determined for a future point in time tₙ by discarding system states from the set of determined similar system states S_{tn,sim} is illustrated in FIG. 4 using the example of two nodes at point in time t₂, specifically concerning the system states S_{t2,7} and S_{t2,11}. The two system states S_{t2,7} and S_{t2,11} are similar, as the state parameter has a similar value and the compressor operating state combination (“nL₁/L₂”) is the same. These two nodes are combined to form one node. The node of the system state S_{t2,11} is the more energetically favorable one and is retained. The system state S_{t2,7} is discarded. This reduces the number of nodes at time t₃ from 64 to only 60, for example. Only from the remaining node, which corresponds to the system state S_{t2,11}, further possible compressor operating state combination sequences CSseq_{tn+1,m} are pursued at the next point in time tₙ₊₁ (here CSseq_{t3,m} at point intime t₃, wherein m=37, . . . , 40, i.e. CSseq_{t3,37}, CSseq_{t3,38}, CSseq_{t3,39} and CSseq_{t3, 40}). This reduction in the number of nodes is based on the discretization of the state variable into discrete value ranges, for example into pressure value ranges Δpᵢ, as described below. The advantageous effect of this procedure according to the method of the invention on the limitation of the solution space is illustrated in FIG. 6.

To determine similar system states S_{tn,sim}, the system pressure p is preferably divided into a predetermined number of discrete pressure value ranges Δpᵢ (for example, into several value ranges of 0.02 bar each). All system states Sₜₙ of the point in time tₙ that have a value of the state parameter that is indicative of a value of the system pressure p in the specific defined pressure value range Δpᵢ are similar with regard to the state parameter. In addition, similar system states Sₜₙ must have at least partially matching compressor operating state combinations CSₜₙ in order to also be considered similar with regard to the states of the compressors C1, C2.

If a system state S_{tn,m} determined for a future time tₙ is similar to another system state S_{tn,m} determined for this time with regard to the state parameter, which is in particular indicative of the system pressure p, and both system states S_{tn,m} match (at least partially) with regard to the compressor operating state combination CSₜₙ corresponding to this time tₙ in each case, it is ensured in particular that one of the two system states S_{tn,m}, based on an evaluation with regard to the (first) quality criterion, can be discarded without losing the option of being able to determine the optimum compressor operating state combination sequence CSseqₒₚₜ. The future system states S_{tn,m} are preferably further defined by at least one software-related control state parameter tₛₜₐₜₑ, which indicates the state of the control algorithm of the compressor system 100. The control state parameter tₛₜₐₜₑ indicates the previous operating time of a compressor C1, C2 in the same defined possible operating state, i.e. the dwell time in the current operating state, in particular in idle mode. The similar system states S_{tn,sim} are preferably each defined by similar values of the state parameter, by a matching compressor operating state combination CSₜₙ and additionally by a matching value of the control state parameter tₛₜₐₜₑ.

From the set of similar system states S_{tn,sim}, the one whose compressor operating state combination sequence CSseqₜₙ best fulfills the (first) quality criterion is determined. In this embodiment, only the most energetically advantageous of the similar system states S_{tn,sim}, or its accounts, is pursued further. All other similar system states S_{tn,sim}, or their nodes, are discarded. The evaluation of the energy efficiency using the (first) quality criterion is based on the determination of the operating state combination sequence CSseq_{tn,m} of all similar system states S_{tn,sim}, which would cause the lowest energy consumption of the compressor system 100 if the compressors C1, C2 were to run through the entire compressor operating state combination sequence starting from the initial time t₀ up to the future time tₙ. In concrete terms, the energy consumption E indicates how much (electrical) energy would be required to get from the initial system state Sₜ₀ (root node) to the specific system state S_{tn,m} (m^{th} node at point in time tₙ), which corresponds to a similar system state S_{tn,sim}. The respective energy consumption E is calculated. At least one of the following parameters can be included in the calculation of the energy consumption E (see FIGS. 7, 8 and 9):
a switching energy Eₛₜₐᵣₜ for the start of a compressor C1, C2;
a switching energy E_{loading} for the pressure build-up of a compressor C1, C2;
a switching energy E_{unloading} for the pressure reduction of a compressor C1, C2;
an idle power P_{idle} of a compressor C1, C2;
a pressure-dependent load capacity P_{load}(p) of a compressor C1, C2.

Based on the reduced set of future system states Sₜₙ at point in time tₙ, further future system states Sₜₙ₊₁ of the compressor system 100 can be determined. The state parameter for at least one further future point in time tₙ₊₁ is calculated by simulation, in each case based on the initial system state Sₜ₀ of the compressor system 100 and a further possible compressor operating state combination sequence CSseq_{tn+1,m}. A compressor operating state combination sequence CSseq_{tn,m}, which corresponds to a system state from the limited set of system states Sₜₙ of a previous future point in time tₙ, forms the first part of the further possible compressor operating state combination sequence CSseq_{tn+1,m}.

When the last node level of the tree, i.e. the end of the simulation period tₛᵢₘ, is reached, the nodes and the corresponding system states Sₜₙ as well as compressor operating state combination sequences CSseq_{tn,m} are known, which can lead to the optimal solution of the given optimization problem. The optimal compressor operating state combination sequence CSseqₒₚₜ can be determined from the compressor operating state combination sequences CSseq_{tn,m} of the last point in time tₙ based on the (second) quality criterion. Since each compressor operating state combination sequence CSseq_{tn,m} is assigned a sequence of control command combinations or let command combinations (path along the node connections), the control commands for the compressors can be determined which can bring about the implementation of the optimum compressor operating state combination sequence CSseqₒₚₜ in the real compressor system 100. Preferably, only the temporally first control command combination is output to the compressors C1, C2. The control command combination LC1/LC2 issued thus corresponds to the transition from the compressor operating state combination CSₜ₀, which corresponds to the initial system state Sₜ₀, to that compressor operating state combination CSₜ₁ which corresponds to the subsequent future system state Sₜ₁, both of which are part of the optimum compressor operating state combination sequence CSseqₒₚₜ. With regard to the entire simulation period tₛᵢₘ, the control command issued results in the optimum operation of the compressor system in terms of energy efficiency from the current perspective.

The method steps are then run through again starting from the current point in time, which preferably corresponds to real time, in order to search again for the current optimum solution and control the compressor system 100 accordingly. This procedure makes sense, as the compressed air consumption can change within a short time, especially within one time step. This results in a different compressed air consumption for the forecast period under consideration, wherein the boundary conditions of the optimization problem can change fundamentally. Due to the reduced demands on the computing capacity, the method can be executed repeatedly at short intervals, in particular in real time, and in this way also take into account dynamic changes or fluctuations in the compressed air consumption estimated for the future.

For the control of the compressor system for compressed air generation, prediction periods are preferably at least 10 minutes, wherein the time resolution is preferably time steps of 1 second or less. In a practical application of the method, the tree structures shown in FIGS. 3 to 5 would therefore have considerably more points in time tₙ and system states S_{tn,m}. For example, for a simulation duration of 10 minutes and a time step of 1 second, the system states S_{tn,m} would have to be considered for 600 future points in time t₁-t₆₀₀. In addition, compressor systems can comprise more than two compressors, which significantly increases the number of possible combinations. The advantages of the method become all the more apparent the more points in time and compressors are considered.

FIG. 5 shows a section of a tree structure for an embodiment of the method for controlling a compressor system with several variable-speed compressors C1, C2. In addition to the previously described defined possible operating states os of a compressor “Standby”, “Idle” or “Load”, the defined additional possible operating states of this embodiment indicate different speeds of a compressor C1, C2. The possible operating states of a compressor specify the speed as discrete speed steps in the form of the percentage of the maximum speed of the compressor. For example, the speed is defined as a load command with 0%, 25%, 50%, 75% or 100% of the maximum speed. In this example of a possible implementation, the two possible operating states or load commands for a fixed-speed compressor (nL or L, see FIGS. 3 and 4) now become six possible load commands for a variable-speed compressor (nL, L_{0%}, L_{25%}, L_{50%}, L_{75%}, L_{100%}). For a tree structure for two variable-speed compressors, starting from a node at time step tₙ, there are 31 possible load command combinations for the subsequent time step tₙ₊₁ (see FIG. 5). Each of the two compressors C1 and C2 can either be switched to “no load” (nL₁ or nL₂) or to “load” at a specific speed. For example, the load command combination nL₁/L_{25%,2} means that compressor C1 is switched to “no load” and compressor C2 is switched to load at 25% speed. At the next point in time, all of the above load command combinations must be considered again. In this way, the tree structure is built up from t₀ via t₁, t₂ to finally tₙ, as previously described in connection with FIGS. 3 and 4. The number of possible compressor operating state combinations CSₜₙ, the future system states S_{tn,m} and consequently the compressor command state combination sequences CSseq_{tn,m} increases considerably by taking variable speed compressors into account. The advantages of the method according to the invention are even more apparent here.

FIG. 6 shows the advantages of the method according to the invention (FIGS. 6B and 6C) compared to a brute force approach from the prior art (FIG. 6A). In each case, the progression of the number of possible compressor operating state combination sequences CSseq_{tn,m} over time is shown, which corresponds to the number of system states S_{tn,m} or nodes of a correspondingly constructed tree structure to be considered.

While the number of nodes for a brute force approach, which maps every possible combination, grows exponentially over time (see FIG. 6A), the method according to the invention has a limiting effect on the number of nodes that can be controlled. It can be seen that the number of nodes remains limited after an initial increase from a certain point in time (see FIGS. 6B and 6C).

FIG. 6B illustrates a method according to the invention with discarding system states S_{tn,m} based on the consideration of the lower pressure limit pₘᵢₙ and the upper pressure limit pₘₐₓ as well as discarding similar system states S_{tn,sim} based on the discretization of the system pressure p into pressure value ranges Δpᵢ.

FIG. 6C shows the additional effect of an optional process step of cyclic reduction of system states S_{tn,m} compared to FIG. 6B. In cyclic reduction, the system states Sₜₙ determined for a future point in time tₙ are discarded based on a quality criterion after a defined number of time steps Δt, for example at cyclic intervals of 20 seconds. In addition to the method steps described for reducing system states S_{tn,m} based on similar system states S_{tn,sim} or limits to be observed for the state parameter (see FIG. 6B), those system states S_{tn,m} that fulfill a quality criterion, preferably an energy efficiency criterion, worse than others can be discarded cyclically. The energy consumption E for the respective compressor operating state combination sequence CSseq_{tn,m} on which the evaluation with regard to the quality criterion is based is preferably calculated as described above. For example, only the 10-50%, preferably the 20%, most energy-efficient system states S_{tn,m} can be pursued further.

FIG. 6 illustrates that the method according to the invention reduces the calculation complexity in such a way that an exponential dependence of the number of nodes on the length of the forecast period is limited to a linear dependence, in the case of FIG. 6B constantly linear. This creates the prerequisite for using the method to control a real compressor system 100.

FIG. 7 shows the determination of future system states S_{tn,m} using a simulation model as a hybrid automaton. The hybrid automaton models discrete operating states, in this case the defined possible operating states (in FIG. 7 “os”) of a compressor, as automaton states that are linked to each other via so-called directed edges. The directed edges are used to define which state transitions are possible in the system and under which conditions a transition takes place (transition condition). In an automaton state, differential equations describe the system behavior. When a state transition occurs, it is possible to reinitialize state variables. For the purposes of illustration, the hybrid automaton shown here represents the structure of a simplified mathematical model for mapping the dynamic behavior of a compressor system with one compressor. A hybrid automaton for a compressor system with two or more compressors would have to be extended accordingly.

The hybrid automaton distinguishes between the three discrete states “Standby” (standstill), “Idle” (idle) and “Load” (load run). If the automaton is in the discrete “Standby” state and a load command is present (LC equals “true”), a transition to the discrete “Idle” state takes place. During the transition from the discrete “Standby” state to the discrete “Idle” state, the control state parameter tₛₜₐₜₑ is initialized with the value 0 and the energy consumption E is reinitialized with the value E+Eₛₜₐᵣₜ, which corresponds to an increase in the energy consumption E by the value Eₛₜₐᵣₜ. While the “idle” state is assumed, the energy consumption E increases by the value P_{idle}*1s with each execution of the hybrid automaton, wherein the assumption is made here that a time step Δt covers a time span of 1s.

In this simple model, the three states of compressor C1 or C2 (standby, idle, load) are linked by means of specific switchover conditions. This enables the transition from one operating state to another, provided the switchover conditions are met.

No energy is required in the “Standby” state, so the new energy value E⁺ is equal to the previous energy value E. The compressor does not produce any compressed air, so DVFR=0 (Delivery Volume Flow Rate). The system pressure p results from the compressed air volume contained in the buffer volume V minus the consumption volume flow rate CVFR(t) (Consumer Volume Flow Rate) as a function of the ambient pressure p_{amb}. When the load changes from “Standby” to “Idle”, tₛₜₐₜₑ is set to 0 and the energy Eₛₜₐᵣₜ is required for the start.

In the “Idle” state, the compressor requires the idle power P_{idle} in each time step. The amount of compressed air produced DVFR is still 0 m³/s, as the inlet valve of compressor C1 or C2 is closed and it cannot deliver any compressed air to the connected compressed air network, as the minimum pressure non-return valve typically provided (not shown in FIG. 1) is closed. The minimum pressure non-return valve only releases compressed air to the connected compressed air reservoir R1 or a consumer 200 connected via a compressed air network when the internal pressure in the oil separator tank of the compressor C1, C2 is higher than the system pressure p. In addition, the minimum pressure non-return valve only opens from a set minimum pressure of the internal pressure in the oil separator tank, e.g. if the internal pressure is greater than 4 bar. The system pressure p and the system air volume (compressed air volume) NV stored in the buffer volume V are calculated in the same way as in the “Standby” state.

In this simple model, the pressure build-up of the compressor is realized via a time counter for a minimum runtime t_{loading}. As soon as t>t_{loading}, the compressor can switch to the “Load” operating state, wherein t is the time elapsed since the start of the calculation. It is also possible to switch to the “Standby” state in the same way, but the condition of the time counter for the minimum idle time t_{coasting} must be fulfilled. This is a simple implementation of a required idle time before a compressor can be switched to standby, i.e. switched off.

In the “Load” state, the variables E⁺, DVFR, p and NV⁺ are calculated in the same way as the formulas in FIG. 7. Starting from the “Load” state, the model can be switched back to the “Idle” state if the corresponding load command LC=false is present. The switching energy for pressure reduction is taken into account via the parameter E_{unloading}.

In order to extend this simplified model for a one-compressor system to a two-compressor system with two compressors C1, C2, significantly more discrete operating states must be considered, among other things. Instead of the three defined possible, i.e. discrete, operating states (standby, idle, load), there are nine discrete compressor operating state combinations for the model of a two-compressor system, namely:
Compressor 1 standby/Compressor 2 standby
Compressor 1 idle/Compressor 2 standby
Compressor 1 standby/Compressor 2 idle
Compressor 1 idle/Compressor 2 idle
Compressor 1 load/Compressor 2 standby
Compressor 1 load/Compressor 2 idle
Compressor 1 standby/Compressor 2 load
Compressor 1 idle/Compressor 2 load
Compressor 1 load/Compressor 2 load

The individual discrete compressor operating state combinations CSₜₙ and the possible transitions for each state to discrete compressor operating state combinations CSₜₙ₊₁ in the following time step are listed in the following table:

| Previous operating status | | | The following | |
|---|---|---|---|---|
| combinations | | | operating state combinations | |
| Compressor 1 | Compressor 2 | | Compressor 1 | Compressor 2 |
| Standby | Standby | → | Standby | Standby |
| | | → | Idle | Standby |
| | | → | Standby | Idle |
| | | → | Idle | Idle |
| Idle | Standby | → | Idle | Standby |
| | | → | Standby | Standby |
| | | → | Load | Standby |
| | | → | Load | Idle |
| | | → | Idle | Idle |
| | | → | Standby | Idle |
| Standby | Idle | → | Standby | Idle |
| | | → | Standby | Standby |
| | | → | Standby | Load |
| | | → | Idle | Load |
| | | → | Idle | Idle |
| | | → | Idle | Standby |
| Idle | Idle | → | Idle | Idle |
| | | → | Standby | Standby |
| | | → | Idle | Standby |
| | | → | Standby | Idle |
| | | → | Idle | Load |
| | | → | Load | Idle |
| | | → | Load | Load |
| | | → | Standby | Load |
| | | → | Load | Standby |
| Load | Standby | → | Load | Standby |
| | | → | Load | Idle |
| | | → | Idle | Standby |
| | | → | Idle | Idle |
| Load | Idle | → | Load | Idle |
| | | → | Load | Standby |
| | | → | Load | Load |
| | | → | Idle | Idle |
| | | → | Idle | Standby |
| | | → | Idle | Load |
| Standby | Load | → | Standby | Load |
| | | → | Idle | Load |
| | | → | Standby | Idle |
| | | → | Idle | Idle |
| Idle | Load | → | Idle | Load |
| | | → | Standby | Load |
| | | → | Load | Load |
| | | → | Idle | Idle |
| | | → | Standby | Idle |
| | | → | Load | Idle |
| Load | Load | → | Load | Load |
| | | → | Load | Idle |

According to these possible combinations of operating states of compressors C1 (compressor 1) and C2 (compressor 2) and transitions between operating state combinations, an extended hybrid automaton for mapping the dynamic behavior of a two-compressor system could be represented analogously to FIG. 7. Within the nine compressor operating state combinations, which correspond to the states of the automaton, the system behavior is again described by differential equations that largely correspond to those in FIG. 7.

An alternative representation of the determination of future system states S_{tn,m} for a two-compressor system using a simulation model is shown in FIG. 8 in the form of a Petri net. This form of representation includes the possible transition conditions between the various compressor operating state combinations. Further boundary conditions for the transition from one operating state combination to another are integrated in the specified transition conditions.

The Petri net models discrete operating states for two compressors located in a two-compressor compressed air station. The left part of the Petri net describes the three operating states of the first compressor C1. The right part of the Petri net describes the three operating states of the second compressor C2. The three operating states are standby (standstill), idling and load running. The calculation of the system pressure p is described in the middle section of the Petri net. The system pressure p results from the system air volume (compressed air volume) NV stored in the buffer volume V as a function of the ambient pressure p_{amb}. The calculation of the stored system air volume NV is determined in each time step after the delivery volume flows DVFR1 and DVFR2 of the respective compressors C1 and C2 have been calculated. The stored system air volume NV in the current time step NV⁺ can be calculated from the stored system air volume in the previous time step NV⁻, the two delivery volume flows DVFR1 and DVFR2 and the consumption volume flow CVFR(t).

The left and right parts of the Petri net describe the respective operating status of the two compressors C1 and C2. In the following, the explanation refers exclusively to the left part and the operating states of the first compressor C1. The explanation applies identically to the right-hand section for the second compressor C2. The Petri net in FIG. 8 is designed in such a way that the two compressors C1 and C2 are operated independently of each other and there are no dependencies between the operating states.

The left part of the Petri net distinguishes three discrete nodes, wherein the term “node” in this context should not be confused with the previously described nodes of the branched tree structure (see FIGS. 3-5):
“Standby” (standstill), top node,
“Idle” (idle), middle node,
“Load” (load run) lowest node.

In the discrete “Standby” state, the current time t1⁺ is determined from the time of the previous step t1⁻. The dwell time in the “Standby” state t1ₛₜₐₜₑ is not relevant for the calculation in the simplified model and remains unchanged at 0s. In the “Standby” state, no electrical energy E is required and the total energy E1⁺ corresponds to the total energy of the previous time step E1⁻. As no compressed air is produced, the amount of compressed air generated DVFR1 is equal to 0 m³/s.

If a load command is present (LC1 is “true”), a transition to the discrete “Idle” state takes place. During the transition from the discrete “Standby” state to the discrete “Idle” state, the control state parameter tstate1⁺ is initialized with the value 0 and the energy consumption E1⁺ is reinitialized with the value E1⁻+E1ₛₜₐᵣₜ, which corresponds to an increase in the energy consumption E1 by the value E1ₛₜₐᵣₜ.

While the “idle” state is assumed, the energy consumption E increases by the value P_{idle}*1s with each execution of the hybrid automaton, wherein the assumption is made here that a time step Δt covers a time span of 1s. The amount of compressed air produced DVFR1 is still 0 m³/s, as the inlet valve of compressor C1 is closed and it cannot deliver any compressed air to the connected compressed air network. In this simple model, the pressure build-up of compressor C1 is realized via the time counter t1ₛₜₐₜₑ. As soon as t1ₛₜₐₜₑ>t₁ loading, the compressor can switch to the “Load” operating state, wherein t₁ state indicates the time spent in the current operating state. It is also possible to switch to the “Standby” state, but the time counter condition for the minimum idle time t_{coasting} must be met. This is a simple implementation of a required idle time before a compressor can be switched to standby, i.e. switched off.

In the “Load” state, the variables E1⁺, DVFR1 are calculated in the same way as the formulas in FIG. 7. Starting from the “Load” state, the model can be switched back to the “Idle” state if the corresponding load command LC1=false is present. The switching energy for the pressure reduction is taken into account via the parameter E1_{unloading}.

FIG. 9 shows an embodiment of the method according to the invention with possible heat recovery as a hybrid automaton. In this embodiment of the method, the evaluation of the compressor operating state combination sequences CSseq_{tn,m} with regard to a quality criterion is not only based on the, preferably electrical, energy consumption of the compressors C1, C2, but also takes into account a possible heat recovery (“WRG” in FIG. 9). A recoverable amount of heat is determined in particular by the amount of heat that can be recovered from an oil circuit (not shown in FIG. 1) of the compressor system 100, which in turn depends on the heat output of the compressors C1, C2. By compressing the air in the compressors C1, C2, heat is transferred, for example, to an oil circuit for cooling the compressors C1, C2, which may be designed as oil-injected compressors, preferably as oil-injected screw compressors. Via a heat exchanger (not shown in FIG. 1) of the compressor system 100, at least part of the heat output generated by the compressors C1, C2 can be recovered and preferably used for an external heat consumer, for example for heating a room outside the compressor system 100. As an alternative or in addition to heat recovery from an oil circuit, the amount of heat that can be recovered from a compressed air flow, preferably at the outlet of compressor C1, C2, can be determined.

When considering the overall energy efficiency as a quality criterion, it may be more favorable in terms of energy to allow a compressor C1, C2 to continue running at idle, although it should actually be switched to standstill when its energy consumption is considered in isolation, as possible heat recovery can have an overall positive effect on the energy balance. The energy consumption of compressor C1, C2 in idle mode is relatively low, so that residual heat stored in the oil circuit can be used for heat recovery during continued operation in idle mode to increase overall energy efficiency.

Modeling using analytical equations can be used to take possible heat recovery into account. If these would result in a considerable increase in computational effort, optimization based on metamodels can be used. Here, correlations between variables are learned using suitable metamodels before the actual optimization. These metamodels can be, for example
Response surfaces with linear, quadratic or cubic approach functions;
Artificial neural networks;
Support Vector Regression;
Gaussian processes.

The hybrid automaton shown in FIG. 9 is extended compared to the illustration in FIG. 7 and functions analogously. The automaton shows the structure of a simplified mathematical model for simulating the dynamic behavior of a single-compressor station, taking into account a heat recovery circuit for utilizing the heat contained in the oil, which is generated during the compression of the air in the compressor block of compressor C1 or C2. The model in FIG. 7 is extended by further relevant parameters, such as the temperature of the oil Toil in the oil circuit, the ambient temperature T_{amb}, the heat quantity of the compressor W, the heat recovery variable WRG, the heat quantity Heat, which can be recovered by means of the heat recovery circuit, as well as parameters for describing the cooling behavior W_{Abkuehl}(tₛₜₐₜₑ, T_{amb}, Tₒᵢₗ⁻) (metamodel) and the heating behavior W_{aufheiz}(tₛₜₐₜₑ, T_{amb}, Tₒᵢₗ⁻) (metamodel) of the compressors C1 or C2. In addition, parameters deltaToilAbkuehl(tₛₜₐₜₑ, T_{amb}, Tₒᵢₗ⁻) are determined for the cooling behavior of the oil temperature, deltaToilIdle(tₛₜₐₜₑ, T_{amb}, Tₒᵢₗ⁻) for the heating behavior of the oil temperature in the idle operating state and deltaToilLoad(tₛₜₐₜₑ, T_{amb}, Tₒᵢₗ⁻) for the heating behavior of the oil temperature in the load operating state. The energy consumption E describes the electrical energy consumed since the start of the calculation. The recoverable amount of heat can be calculated according to the formulas shown in FIG. 9. For a two-compressor station, the hybrid automaton can be extended to include the discrete compressor operating state combinations from Table 1.

WRG describes the ability whether heat recovery can be used or not and assumes the values true or false. In the standby state (standstill) of compressor C1 or C2, no heat recovery can take place. This is due to the fact that the oil circuit is no longer active in standby mode and therefore no oil can be pumped through the heat exchangers of the heat recovery system. As a result, the usable heat quantity HEAT⁺ that can be dissipated via the heat recovery system WRG is also zero.

In the standby state, there is no compression of air and no heat is transferred to the oil during compression. Consequently, the temperature of the oil Tₒᵢₗ in the oil circuit of the compressor drops. This cooling occurs relatively slowly and can be represented by a cooling function (deltaToilAbkuehl) as a function of the dwell time in the standby state tₛₜₐₜₑ, the ambient temperature T_{amb} and the oil temperature in the previous time step Tₒᵢₗ⁻. Accordingly, the amount of heat stored in the compressor W can also be described as a function of the parameters tₛₜₐₜₑ, T_{amb} and Tₒᵢₗ⁻ by a cooling function (WAbkuehl). The dwell time in the standby state tₛₜₐₜₑ is modelled analogously to the two states Idle and Load and initialized with 0s each time the state changes to standby.

In the idle state, the increase in oil temperature Tₒᵢₗ and the stored heat quantity W can be mapped with functions (deltaToilIdle, W_{aufheiz,Idle}), which model the increase in idling. Heat recovery can only be used in the idle state if there is a system-specific stored heat quantity greater than a certain threshold value W_{threshold}. Alternative modeling can also be carried out using a predetermined threshold value for Tₒᵢₗ⁺. If the threshold value is exceeded, heat can be recovered (WRG:=true) and the amount of heat Heat⁺ that can be dissipated can be determined using a further function HEAT as a function of the oil temperature Tₒᵢₗ and the amount of heat W⁺ in the current time step. If the temperature falls below the threshold value, no heat recovery can be used (WRG:=false) and the amount of heat Heat⁺ that can be transferred is zero.

In the load state (Load), the variables Toil⁺, W⁺, WRG, Heat⁺ can be determined in the same way as in the Idle operating state. However, a different heating function (deltaToilLoad) and a different function for determining the heat quantity W⁺ (W_{aufheiz,Load}) are used.

The method according to the invention described in connection with the compressor system 100 and the control unit 300 according to the invention ensure optimum control of the compressor system 100 in terms of energy efficiency in order to provide the required consumption of compressed gas (compressed air). The control method can consider a long forecast period with fine time discretization due to reduced requirements on the computing capacity and, in particular, can be executed in real time. Dynamic fluctuations and changes in compressed air consumption as well as dynamic processes in the compressor system can be taken into account by the control system at an early stage. The method (implicitly) considers all possible control command combinations for compressors C1, C2. The quality of the solution found by the control method for the control command combination to be issued depends in terms of optimality only on the quality of the prediction of future compressed air consumption.

At this point, it should be noted that all the features of the invention described above, taken individually and in any technically meaningful combination, in particular the details shown in the drawings, form part of the invention.

### LIST OF REFERENCE SIGNS

100 Compressor system
200 Consumer
300 Control unit
C1, C2 Compressors
R1 Compressed air reservoir
LC, LC1, LC2 Control command (load command)
LC1/LC2 Control command combination (load command combination)
S_{tn,m} Future system states
Sₜₙ Future system states for a future point in time tₙ
Sₜₙ₊₁ Future system states for a future point in time tₙ₊₁
Sₜ₀ Initial system state
S_{tn,sim} Similar system states
t₀ Initial point in time
t₁ First future point in time
tₙ, tₙ₊₁ Future points in time
Δt Time step
t Time since start of calculation
tₛᵢₘ Simulation period
CSₜ₀ Compressor operating state combination at point in time t₀
CSₜ₁ Compressor operating state combination at point in time t₁
CSₜₙ Compressor operating state combination at point in time tₙ
CSseq_{tn,m} Compressor operating state combination sequence
CSseq_{tn+1,m} Possible compressor operating state combination sequence
CSseqₒₚₜ Optimum compressor operating state combination sequence
p System pressure
Δp Pressure range
pₘᵢₙ Lower pressure limit
pₘₐₓ Upper pressure limit
Δpᵢ Pressure value range
NV System gas quantity (system gas volume)
V Buffer volume of the compressor system
p_{amb} Ambient pressure
T_{amb} Ambient temperature
Tₒᵢₗ Temperature of the oil in the oil circuit
tₛₜₐₜₑ Control state parameter
OS Operating status of a compressor (standby/idle/load)
E Energy consumption
E_{Start} Switching energy for starting a compressor
E_{loading} Switching energy for the pressure build-up of a compressor
E_{unloading} Switching energy for depressurizing a compressor
P_{idle} Idle running power of a compressor
P_{load}(p) Load running power of a compressor, pressure-dependent
t_{coasting} Minimum idling time before a compressor may be switched to standstill
t_{loading} Minimum idling time for pressure build-up before a compressor can be switched to load mode
W Stored heat quantity of the compressor
W_{threshold} Threshold value for stored heat quantity of the compressor
WRG Heat recovery variable
Heat Amount of recoverable heat via heat recovery cycle
W_{Abkuehl} Cooling behavior of the compressor (metamodel)
W_{aufheiz} Heating behavior of the compressor (meta model)
deltaToilAbkuehl Cooling behavior of the oil temperature
deltaToilIdle Heating behavior of the oil temperature in idle operating state
deltaToilLoad Heating behavior of the oil temperature in load operating state
DVFR(p) Delivery volume flow, pressure-dependent
CVFR(t) Consumption volume flow rate, time-dependent

1. Method for controlling a compressor system comprising a plurality of compressors for generating compressed gas, in particular compressed air, for at least one consumer, comprising:
Determining a plurality of future system states of the compressor system for at least one future point in time,
wherein the future system states are defined by at least one state parameter and a compressor operating state combination,
wherein values of the state parameter for the at least one future point in time are calculated by simulation based on an initial system state of the compressor system, a future consumption curve of the compressed gas, and a possible compressor operating state combination sequence, wherein a compressor operating state combination indicates a combination of defined possible operating states of the compressors of the compressor system for a future point in time,
wherein a compressor operating state combination sequence indicates a time sequence of compressor operating state combinations;
Determining similar system states from the set of future system states determined for a future point in time,
wherein the similar system states are each defined by similar values of the state parameter and at least partially matching compressor operating state combinations, wherein similar values of the state parameter are each in the same defined value range;
Reducing the set of system states determined for a future point in time by discarding at least one system state from the set of determined similar system states based on an evaluation of the compressor operating state combination sequences corresponding to the respective similar system states with respect to a first quality criterion;
Determining an optimal compressor operating state combination sequence based on an evaluation of those compressor operating state combination sequences which correspond to a system state from the reduced set of system states with respect to a second quality criterion;
Issuing at least one control command which is suitable for effecting an operation of the compressors of the compressor system which corresponds to at least part of the optimum compressor operating state combination sequence.

2. Method according to claim 1,
characterized in that the state parameter indicates a system gas quantity stored in the compressor system, wherein the system pressure can be derived from the system gas quantity.

3. Method according to claim 1,
characterized by
rejecting those system states determined for a future point in time which are indicative of a system pressure which lies outside a predetermined pressure range for a pressure to be provided by the compressor system.

4. Method according to claim 1,
characterized by
determining further future system states of the compressor system by calculating the state parameter for at least one further future point in time by simulation, in each case based on the initial system state of the compressor system and a further possible compressor operating state combination sequence, wherein a compressor operating state combination sequence, which corresponds to a system state from the limited set of system states of a preceding future point in time, is part of the further possible compressor operating state combination sequence.

5. Method according to claim 1,
characterized in that future system states of the compressor system are determined for the future points in time contained in a predetermined simulation period, wherein the simulation period is subdivided into equidistant time steps.

6. Method according to claim 1,
characterized by
cyclic discarding of those system states determined for a future point in time based on the first quality criterion and/or the second quality criterion, wherein a time step indicates the distance between two successive points in time.

7. Method according to claim 1,
characterized in that the future system states are mapped by a branched data structure in a computer memory, wherein a future system state corresponds to a node of the branched data structure and the branched data structure comprises a plurality of node levels, wherein certain future system states for a future point in time are each assigned to the same node level.

8. Method according to claim 1,
characterized in that the at least one control command is issued when the future system states of the compressor system are determined for the future points in time contained in a predetermined simulation period and the optimum compressor operating state combination sequence is determined, wherein the at least one control command issued is a control command combination for a plurality of compressors of the compressor system.

9. A method according to any claim 1,
characterized in that the at least one issued control command, corresponds to the transition from the compressor operating state combination corresponding to the initial system state to that compressor operating state combination corresponding to the subsequent future system state, which is part of the optimum compressor operating state combination sequence.

10. Method according to claim 1,
characterized in that the evaluation with regard to the first quality criterion and/or the second quality criterion is based on a calculated energy consumption of the compressors when passing through a compressor operating state combination sequence from the initial point in time to the respective point in time, wherein the optimum compressor operating state combination sequence is in particular that compressor operating state combination sequence which has the lowest calculated energy consumption of the compressors.

11. Method according to claim 10,
characterized in that at least one of the following parameters is included in the calculation of the energy consumption:
a switching energy for starting a compressor;
a switching energy for the pressure build-up of a compressor;
a switching energy for the pressure reduction of a compressor;
an idle power of a compressor;
a load capacity of a compressor.

12. Method according to claim 1,
characterized in that the evaluation with respect to the first quality criterion and/or the second quality criterion takes into account a possible heat recovery, wherein the possible heat recovery is determined
by calculating an amount of heat recoverable from an oil circuit of the compressor system
and/or
by calculating an amount of heat that recoverable from a compressed gas flow.

13. Method according to claim 12,
characterized in that the calculation of a recoverable amount of heat is based on at least one of the following parameters:
a temperature of the oil in an oil circuit of the compressor system;
the ambient temperature of the compressor system;
a flow rate of the oil in an oil circuit of the compressor system;
a final compression temperature of the compressed gas;
a specified or calculated heating energy of a compressor;
a specified or calculated cooling energy of a compressor.

14. Method according to claim 1,
characterized in that the defined possible operating states of a compressor indicate at least one rotational speed of the compressor.

15. Method according to claim 1,
characterized in that the future system states are further defined by at least one, in control state parameter, which indicates the state of the control algorithm of the compressor system, wherein the control state parameter indicates the previous operating time of a compressor in the same defined possible operating state, wherein the similar system states are each defined by similar values of the state parameter, by a matching compressor operating state combination and by at least one matching control state parameter.

16. (canceled)

17. Method according to claim 1,
characterized in that at least one of the following parameters is included in the determination of the future system states:
a buffer volume of the compressor system, wherein the buffer volume indicates the volume of the compressor system in which compressed gas is stored during operation;
a delivery volume flow of a compressor;
a consumption volume flow rate of the at least one consumer;
the ambient pressure.

18. Method according to claim 1,
characterized in that the steps of the method are carried out repeatedly one after the other starting from different initial points in time in several method executions, wherein the compressor operating state combination of the optimum compressor operating state combination sequence of the previous method execution corresponding to the first future point in time is used as the compressor operating state combination of the subsequent method execution corresponding to the initial point in time.

19. Control unit for a compressor system comprising a plurality of compressors for generating compressed gas for at least one consumer, wherein
the control unit is designed to carry out at least one step of the method according to claim 1.

20. Compressor system comprising a plurality of compressors for generating compressed gas for at least one consumer and a control unit according to claim 19.

21. Computer program comprising instructions which, when executed on at least one processor, cause the processor to carry out the steps of the method according to claim 1.
